(19) United States
(12) Patent Application Publication
(10) Pub. No.: US 2023/0385959 A1
(43) Pub. Date: Nov. 30, 2023

(54) SYSTEMS AND METHODS FOR USE IN ASSESSING TRIALS IN FIELDS

(71) Applicant: CLIMATE LLC, Saint Louis, MO (US)

(72) Inventors: Taylor AUNE, San Francisco, CA (US); Huan GU, Lake View, NY (US)

(21) Appl. No.: 18/201,734

(22) Filed: May 24, 2023

Related U.S. Application Data
(60) Provisional application No. 63/346,131, filed on May 26, 2022.

(51) Int. Cl. G06Q 50/02; G06Q 10/0639

(52) U.S. Cl. CPC G06Q 50/02; G06Q 10/06393

(57) ABSTRACT

Systems and methods are provided for use in assessing regions (for example, trials) in fields. One example computer-implemented method includes identifying, by an agricultural computer system, two regions in a field for assessment, where at least one of the two regions is associated with an agricultural trial in the field, and generating an aggregate fitness metric for the two regions. In doing so, the aggregate fitness metric is indicative of a similarity between the two regions in the field. The method also includes determining, by the agricultural computer system, whether the aggregate fitness metric satisfies a defined threshold and, in response to determining that the aggregate fitness metric fails to satisfy the defined threshold, automatically discarding the trial.

### CROSS-REFERENCE TO RELATED APPLICATION

This application claims the benefit of, and priority to, U.S. Provisional Application No. 63/346,131 filed on May 26, 2022. The entire disclosure of the above-referenced application is incorporated herein by reference.

### FIELD

The present disclosure generally relates to systems and methods for use in assessing trials in fields (and/or the fields themselves) based on data associated with the trials and/or fields, such as, for example, planting data, treatment data, etc. relating to crops planted in the fields and/or as part of the trials, etc.

### BACKGROUND

This section provides background information related to the present disclosure which is not necessarily prior art.

It is known for seeds to be grown in fields, by growers, for various purposes, including commercial purposes, whereby resulting plants, or parts thereof, are sold by the growers for business purposes and/or profit. Often, the growers may experiment with different variables (e.g., planting rates, etc.) as part of growing the seeds, for example, from seed selection to field treatments, in relatively small parts of the growers' fields. Results from such experiments may then be used to support changes to the selected seeds and/or the treatments of the fields, and associated ones of the variables used in and/or on the fields, in future planting/growing plans.

### SUMMARY

This section provides a general summary of the disclosure, and is not a comprehensive disclosure of its full scope or all of its features.

Example embodiments of the present disclosure generally relate to computer-implemented methods for use in assessing different regions of fields. In one example embodiment, a method for use in assessing one or more agricultural trials in a field generally includes identifying, by an agricultural computer system, two regions in a field for assessment, at least one of the two regions associated with an agricultural trial in the field; generating, by the agricultural computer system, an aggregate fitness metric for the two regions, the aggregate fitness metric indicative of a similarity between the two regions in the field; determining, by the agricultural computer system, whether the aggregate fitness metric satisfies a defined threshold; and automatically discarding, by the agricultural computer system, the trial in response to the determination that the aggregate fitness metric fails to satisfy the defined threshold.

Example embodiments of the present disclosure also generally relate to systems for use in assessing different regions of fields. In one example embodiment, a system includes an agricultural computer system, which is configured, by executable instructions, to: identify two regions in a field for assessment, at least one of the two regions associated with an agricultural trial in the field; and generate an aggregate fitness metric for the two regions, based on relative distances of locations in a first region of the two regions to locations in a second region of the two regions, wherein the aggregate fitness metric is indicative of a similarity between the two regions in the field.

Example embodiments of the present disclosure also generally relate to non-transitory computer-readable storage media comprising executable instructions for assessing regions of fields including, for example, one or more. trials, which when executed by at least one processor, cause the at least one processor to perform one or more of the operations recited in the above example method(s) and/or system(s).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example embodiment of a system for assessing trials in fields (e.g., in target fields, etc.);

FIG. 2 illustrates an example field (e.g., a target field, etc.) that may be included in the system of FIG. 1, and assessed therein, in which an example trial, having three segments, is disposed;

FIGS. 3A-3B illustrate an example field (e.g., a target field, etc.), which is separated into control and test segments, and which provides an indication of a fitness metric of a trial in the field that may be determined, compiled, generated, etc. in connection with an assessment performed via the system of FIG. 1;

FIG. 4 illustrates an example method of determining a fitness metric for a trial in a field (as part of an assessment of the field and/or the trial within the field), where the field includes two regions with a target disparate condition, and where the method may be employed in connection with the system of FIG. 1;

FIGS. 5A-5B illustrate another example field, which is separated into different regions, and provides an indication of a fitness metric for each of the regions, that may be determined in connection with the method of FIG. 4;

FIGS. 6A-6E illustrate an example progression of fitness metrics, that may be generated in connection with the method of FIG. 4;

FIG. 7A depicts an example embodiment of a timeline view for data entry that may be generated and/or displayed in connection with the system of FIG. 1 and/or the method of FIG. 4, and example data that may be included therein;

FIG. 7B depicts an example spreadsheet view for data entry that may be generated and/or displayed in connection with the system of FIG. 1 and/or the method of FIG. 4, and example data that may be included therein;

FIGS. 8A-8B illustrate example logical organization of sets of instructions in main memory of a computing device and/or computer system when an example application is loaded for execution;

FIG. 9 illustrates a programmed process by which the system of FIG. 1 and/or the method of FIG. 4 generates one or more preconfigured agronomic model(s) using agronomic data provided by one or more data source(s); and

FIG. 10 is a block diagram that illustrates an example computer system upon which embodiments of the system of FIG. 1 and/or the method of FIG. 4 may be implemented.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Experiments and/or trials may be used by growers to provide support for changes in seeds selected for planting in fields, for changes in treatments applied to fields and/or crops included in the fields, or for changes in various parameters associated with the crops or with the fields or with the planting and/or harvesting of the crops in the fields, etc. In doing so, the trials may include application of one or more different treatments or combinations of treatments (e.g., fertilizer, herbicide, insecticide, etc.) to different parts of the fields, planting of one or more different types of seeds (e.g., types, varieties, etc.), application of one or more different irrigation settings and/or schedules, implementation of one or more different harvesting schedules, etc. (for example, features of the fields and/or trials). In some examples, the experiments and/or trials may be defined in triplet (or as a triplet), where three strips are provided to account for variations in the field (e.g., two test strips and one control strip; one test strip and two control strips, etc.), or the experiments and/or trials may be defined in other formats of strips (e.g., in two strips, in more than three strips, in other arrangements of test strips and control strips, etc.), or the experiments and/or trials may be defined in spatial configurations other than strips (whereby a particular shape of the experiments and/or trials is not required, etc.), etc.

Uniquely, the systems and methods herein provide for assessing trials (and/or experiments) in fields, based on data associated with the trials and/or fields (e.g., the fields themselves, crops in the fields, etc.). In particular, in one example, different regions in a field are initially identified in which an agricultural trial/experiment is being conducted. An agricultural computer system is configured to then generate an agricultural metric (e.g., a fitness metric, etc.) for the regions, where the agricultural metric is indicative of a similarity between the different regions in the field (e.g., by considering the data associated therewith and the trial(s)/experiment(s) therein, etc.). In connection therewith, the agricultural computer system is configured to evaluate the agricultural metric against one or more thresholds and, when the metric fails the one or more thresholds, to discard (e.g., automatically, etc.) the trial. In this manner, outcomes of the trials may be evaluated, for example, in connection with identifying, recommending, etc. changes to certain parameters of the fields, crops, etc., or not, consistent with the trials (e.g., seeds planted, growing conditions, harvest processes, treatments, etc.).

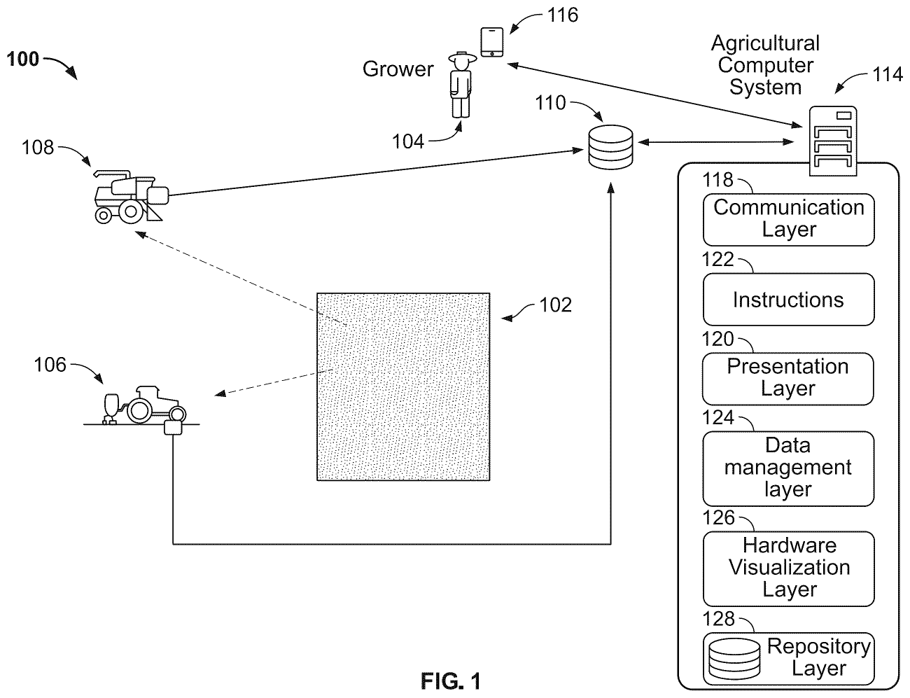

FIG. 1 illustrates an example system 100 in which one or more aspect(s) of the present disclosure may be implemented. Although the system 100 is presented in one arrangement, other embodiments may include the parts of the system 100 (or other parts) arranged otherwise depending on, for example, relationships between users (e.g., growers, etc.) in the system 100, farm equipment used in the system 100 and numbers and/or arrangements of fields, data flows, types of plants included in fields, types and/or locations of fields, numbers and/or types of trials included in fields, planting and/or harvest activities in the fields, privacy and/or data requirements, etc.

As shown in the embodiment of FIG. 1, the system 100 generally includes a field 102 (broadly, a growing space) in which seeds/plants are planted, grown and harvested (e.g., by grower 104, etc.). It should be appreciated that the field 102 is provided for illustration, and that systems consistent with the present disclosure often includes dozens, hundreds or thousands of fields, or more or less, etc., each of which may be subject to the description herein. In general, in this example, the field 102 is owned and/or worked by the grower 104 (and/or by an entity associated with the grower, etc.), who is in the business of planting, growing, and harvesting crops, over a period of various seasons.

In connection therewith, the grower 104 provides for certain farm equipment to be used for planting, growing, treating, and harvesting a crop (or multiple crops), etc. in the field 102. In this example embodiment, the system 100 includes a planter 106 and a harvester 108. The planter 106, for example, is configured to dispense seeds into the field 102 in a particular manner (e.g., in a particular pattern such as in lines, at a particular rate, etc.) over a swath of the planter 106, whereby multiple rows are planted at one time. And, the harvester 108 may include, for example, a combine, a picker, or other mechanism for harvesting plants/crops from the field 102. The harvester 108 may be automated, or reliant, at least in part, on a human operator, etc. The harvester 108, in general, is configured to remove a part of a plant grown from the planted seeds (e.g., an ear of corn, beans from soybeans, grain from wheat, etc.), which is referred to herein as harvesting. The harvester 108 may additionally, or alternatively, perform operations including picking, threshing, cutting, reaping, gathering, etc.

It should be appreciated that other farm equipment may be used in the field 102 (and more generally, in the system 100), including, for example, a sprayer (not shown), which is configured to apply one or more treatments (e.g., chemical treatments, biological treatments, etc.) to the crop(s) in the field 102, prior to planting, after planting and/or prior to harvest of the crop(s). Still other equipment may be employed in the field 102 and configured to perform operations related to the planting, growing, irrigating, or harvesting of the crop(s) therein within the scope of the present disclosure.

As part of the above, the farm equipment (e.g., the planter 106, the harvester 108, etc.) is configured to collect data and to transmit the data to a data server 110. For example, the planter 106 is configured to implement a planting plan for the field 102 and also to compile data specific to at least planting and/or execution of the planting plan. The data (e.g., planting data, etc.) may include, without limitation, seed type/name, seed/row position, location data, planting rate, planting direction, headland location(s), date/time data, or other suitable data, etc. The planter 106 is configured to determine, compile/collect and/or transmit the planting data to the data server 110. Similarly, the harvester 108 is configured to compile/collect data specific to the plant(s) being harvested and to the operation of harvesting of the plant(s), etc. The data (e.g., harvesting data, etc.) may include, without limitation, a location of the field 102 and/or plants (e.g., as expressed in latitude/longitude or otherwise, etc.), yield, weight, moisture content, volume, flow, headland location(s), date/time data, or other suitable data, etc. associated with the harvested crop(s) and/or harvesting operation in the field 102. The harvester 108 is configured to transmit the gathered data to the data server 110.

It should be appreciated that further farm equipment may be included in the field 102, that may also be configured to compile/collect and transmit data to the data server 110. It should be further appreciated that data about the field 102 and/or crop in the field may be compiled and/or collected, and also transmitted to the data server 110, in whole or in part, independent of the farm equipment. For example, certain data related to the field 102, such as, for example, the planting plan, field description or definition (e.g., boundary, soil types, etc.), headland location(s), temperatures, moisture, geology, etc., may also be compiled and/or collected, or may be defined by the grower 104, and transmitted to the data server 110. Moreover, in some example embodiments, data related to the field 102 may be obtained through sensors in and/or around the field 102 (e.g., remote sensors, etc.) and transmitted by the sensors to the data server 110 (e.g., precipitation/moisture data, etc.).

As noted above, in various embodiments, the data collected by the farm equipment (e.g., the planter 106, the harvester 108, etc.) and/or data collected otherwise, and included in the data server 110, may include, for example, boundary data (or boundary line data) for the field 102 (and/or other fields), headland data for the field (and/or for other fields), and direction data of the crop(s) in the field 102. In addition, headland data for the field 102 (and/or for other fields) may be included in the data server 110, for example, as generated based on such data collected by the farm equipment, etc.

In particular, for example, the field 102 is defined by a boundary, which traces an outside perimeter of the field 102, and serves to distinguish the field 102 from other fields or other areas, and specifically, neighboring fields, forests, other property, etc. The boundary may be defined by a legal border, structures (e.g., roads, railroad tracks, etc.), water ways (e.g., rivers, ditches, canals, etc.), or otherwise, etc. It should be appreciated that in some examples the boundary of the field 102, for example, may be defined by the grower 104 to separate contiguous land owned/operated by the grower 104 into more than one field (e.g., the field 102 and another field, etc.). Consistent with the above, in this example, the boundary for the field 102 is defined by coordinates (e.g., as defined by the grower 104 and/or captured by farm equipment, etc.), which are stored in the data server 110.

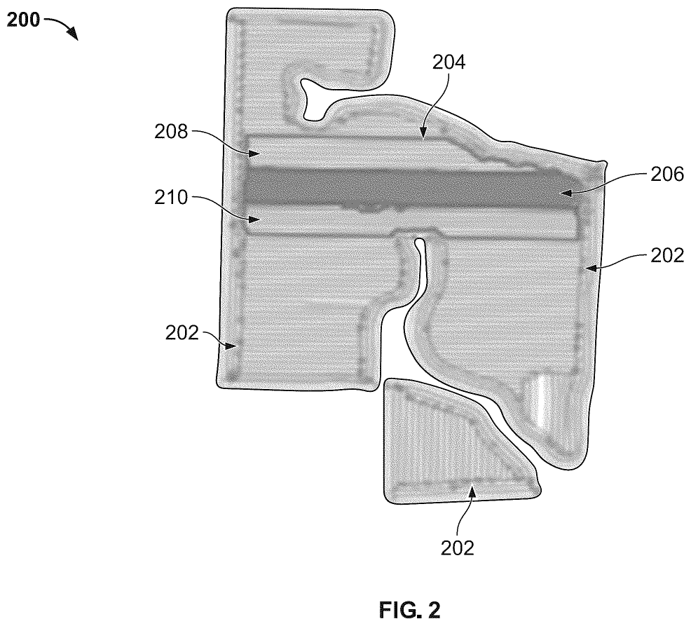

FIG. 2 illustrates an example field 200, which is defined by a boundary. In connection with the boundary, the field 200 also includes parts, areas, regions, portions, etc. which are designated as headlands 202. The headlands 202 are generally a strip or segment or section/portion of land in the field 200 that may be unplanted and/or inaccessible, for example, due to a turn radius of farm equipment in the field 200 (e.g., the planter 106, etc.), or an obstacle in the field 200 (e.g., standing water, utilities, trees, rocks, etc.), or that may be planted with seed but that may have operational abnormalities that could hinder the plants ability to perform. As such, the headlands 202 may include, for example, areas that are driven over during planted, areas used to turn farm equipment around in the field 200, areas that are driven around due to obstacles, or other areas thereby resulting in such operational abnormalities, etc. The headlands 204 may be designated, measured and/or determined based on data received by and/or from farm equipment used in the field 102 to plant, harvest or otherwise interact with the field 200 (e.g., the planter 106, the harvester 108, etc. as shown in FIG. 1, or otherwise; etc.). Additionally, or alternatively, the headlands 202 may be estimated, for example, as a threshold distance from a boundary line and/or missing data for the field 200. For example, the headlands 202 may be defined as a two swath width of farm equipment (e.g., of the planter 106 shown in FIG. 1 (e.g., feet, or more or less, etc.), etc.) from the boundary line of the field 200. Similarly, for example, an obstacle in the field 102, such as a rock, a tree, etc., may prevent planting in that part of the field 200 by the planter 106, whereby planting data for that part of the field 200 is absent. As such, the absence of data for a part of the field 200, for example, may be understood as an obstacle in the field 200 (or a headland 202, more generally), whereby the two swath width may again be applied to define the headland 202 associated with the obstacle. It should be appreciated that headlands within the center of a field, or apart from the boundary line, may be considered, or omitted, in various embodiment herein. Regardless, as shown in FIG. 2, the headlands 202 include the area around the perimeter of the two segments or portions of the field 200. Data indicative of the headlands 202 is stored for the field 200 in the data server 110.

Also shown in FIG. 2, a trial 204 is included in the field 200, where the trial 204, in this example, includes a triplet of strips. It should be appreciated that trials may have configurations and/or shapes other than triplets of strips and/or other than strips in general in other embodiments. For instance, trials may include more than three strips, or trials may include arrangements other than strips (e.g., circles, ovals, or any other desired shape, etc.) In this example, though, where the trial 204 includes the triplet of strips, the center strip 206 is the control strip for the trial 204, and the remaining strips 208, 210 are the test strips for the trial 204.

Referring again to FIG. 1, the data server 110 is configured to store the data received from the farm equipment, or otherwise, in one or more data structures. The data may include, without limitation, planting data (e.g., planting plan, seeds, rates, locations, etc.), harvest data, treatment data, headland data (e.g., locations, etc.), field definitions/boundaries, date/time data, etc.

That said, in general in the system 100, the grower 104 may desire to enhance performance of the crop(s) planted in the field 102. A higher yield, for example, may provide a greater commercial benefit of the field 102. As such, from time to time, the grower 104 may decide to alter one or more conditions of the field 102, for example, as to the type/variety of seeds planted or as to the growing conditions as the seeds grown into plants (e.g., through treatments, irrigation, etc.), and then as to harvesting the crops (e.g., moisture content at harvest, etc.) to determine the success of the alteration(s). Implementing such alteration(s) is generally referred to herein as a trial (or trials or experiment or experiments). In connection therewith, the trial (or multiple trials) may be defined to include one or more treatments or combination of treatments (e.g., fertilizer, herbicide, insecticide, etc.), one or more different types of seeds (e.g., types, varieties, etc.), one or more different irrigation settings and/or schedules, one or more different harvesting schedules, etc. Further, the trial may be specified by the grower 104, or may be designed by a provider of the seeds and/or the treatment(s), or a combination of both, etc.

In connection with the planting by the planter 106, for example, or treatment by farm equipment (e.g., by an aerial sprayer, ground sprayer, etc.), the trial is implemented in the field 102, by the grower 104. The grower 104, then, may desire to assess an outcome (e.g., effectiveness, etc.) of the trial, for example against another trial in the field 102 (or in another field 102) or, more generally, against another part, section, segment, etc. of the field 102 (or another field) that is not part of the trial.

In this example embodiment, the system 100 includes an agricultural computer system 114, which is programmed, or configured, to assess the trial in the field 102 based on the data included in the data server 110, etc. The agricultural computer system 114 may be configured in one or more manners as generally described herein, depending, for example, on the type of data available for the field 102 and/or the test variable(s) included in the trial (e.g., seed rate variance, treatment/no treatment, etc.).

Initially in the system 100, the agricultural computer system 114 is configured to identify two different regions in the field 102 to evaluate (or assess) relative to each other. In doing so, one of the regions may be associated with a trial or experiment (as described above) and one of the regions may not be associated with any trial or experiment. Or, both regions may be associated with a trial or experiment (with the trial or experiment of each region being different).

The regions may be identified in any desired manner. For instance, in one example, the grower 104 may provide input to the agricultural computer system 114 to identify the regions in the field 102. In another example, data indicative of the field 102 may be discrete, as to a treatment of the field (e.g., a chemical treatment, a biological treatment, etc.), for example, whereby the discrete data is stored in the data server 110. And, based on the discrete data, the agricultural computer system 114 may be configured to identify the regions based on the discrete data in the data server 110 (e.g., by overlaying the planting data and the treatment data for the field 102 from the data server 110, etc.). Specifically, the data is indicative of locations in the field 102, for example, by cells or coordinates, whereby a cell is identified as either not planted, planted and not treated, or planted and treated. In doing so, the locations (or cells) may have sizes of about 1 meter by about 1 meter, about 3 meters by about 3 meters, about meters by about 5 meters, about 2 meters by about 5 meters, other larger or smaller sizes, other shapes and/or configurations (e.g., other than square, other than rectangular, etc.) (e.g., circular, triangular, polygonal, otherwise, etc.), etc. Further, it should be appreciated that the locations (or cells) may each be similar in size, or one or more of the locations may be different in size from other ones of the locations. In still another example, the regions may be identified consistent with the description in Applicant's US patent application entitled “Systems and Methods for use in Identifying Trials in Fields,” which is incorporated herein by reference.

Next in the system 100, in this example embodiment, the agricultural computer system 114 is configured to determine a fitness metric for the field 102 (broadly, an agricultural metric or assessment metric), or more specifically, for the two identified regions in the field 102, where one or both of the identified regions include a trial or experiment (e.g., differences in conditions of the crops/planting, etc.).

In particular, in this example embodiment, the agricultural computer system 114 is configured to quantify, as the fitness metric, similarities of the two identified regions in the field 102 where a target condition is different between the regions (e.g., one region including a treated crop and the other region including an untreated crop, etc.), etc. For example, Equation (1) below may be used to determine the fitness metric, F, for the two identified regions in the field 102:

$$F = {\int }_{p ∈ S , q ∈ U} … \int ( w ( d ( p , q ) ) dpdq \qquad ( 1 )$$

$$where$$

$$d = \sqrt{{\sum }_{i = 1 to n} {( {p}_{i} - {q}_{i} )}^{2}}$$

In the above, the fitness metric, F, represents fitness of the trial for a field (e.g., field 102, etc.), based on identified treatment/test regions S and U (or trials, or experiments, etc.) within the field (e.g., one region including a treated crop and the other region including an untreated crop, etc.) and, in particular, between points p, q within the regions (e.g., wherein p, q may be general n-dimensional vectors (e.g., 2-dimensional vectors, etc.), etc.). In addition, d represents the Euclidean distance in n-space (e.g., from i=1 to n, etc.). And, as described more below, w(d) represents a weighting function with respect to points p and q. As generally described above, the treatment/test regions may include two different treatment regions, a control region and a test region, etc.

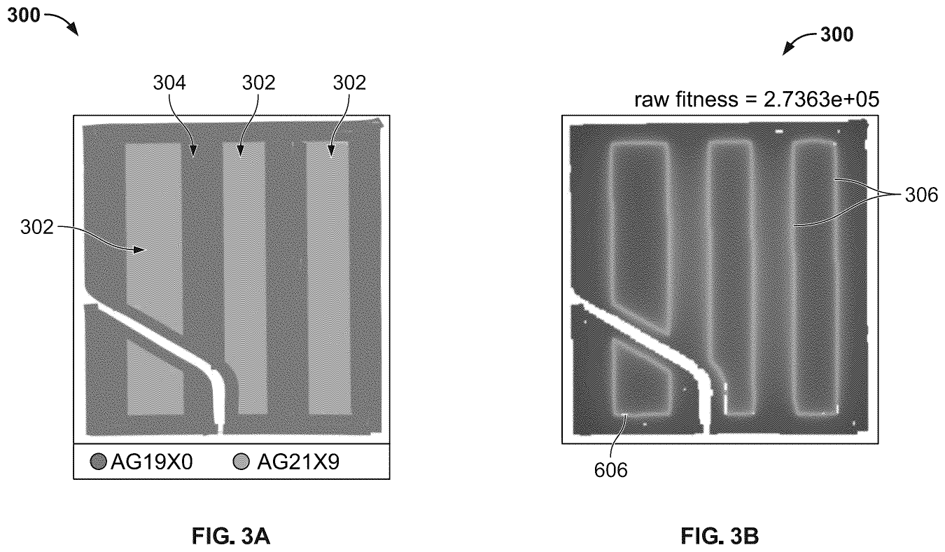

In connection therewith, generally, a distance is determined for each cell or location in one region to each other cell or location in another region. With reference to FIG. 3A, for example, Equation (1) may be used to provide a fitness metric based on a distance between each location (or cell) in test region 302 to each location (or cell) in control region 304 of field 300. The fitness metric for each location is represented in FIG. 3B, where the lighter color (or shading) 306 is indicative of greater similarity of the locations (e.g., greater likeness or equivalence of conditions of the crops/planting at the locations, etc.). Specifically, for example, the lightest coloring 306 is at a border between the test and control regions 302, 304, which are the most similar, while edges around the control region 304 are darker because they are the farthest away from the test regions 302. Referring again to FIG. 1, it should be appreciated that the fitness metric for each location in the field 102 is further combined (e.g., aggregated, etc.) into a single metric (e.g., as an average, as a sum, as a weighted combination, as another combination thereof, etc.), i.e., an aggregate fitness metric, to provide a quantitative metric for the fitness of the field 102 to evidence the effectiveness of a difference between the regions, by way of Equation (1) (and the summation therein). As such, in one example, FIG. 3B and the coloring included therein may be illustrative of the fitness metrics (e.g., based on the different colors, etc.), and the overall image may then be illustrative of the aggregate fitness metric (e.g., based on a number of different colors, etc.). That said, in examples where a field may include n treatments, there may be (n choose 2) unique pairwise combinations of treatment regions and each pairwise combination will have a fitness metric, F.

In this manner, fields, or trials within fields, may be compared to one another, based on the fitness metric, to determine a potential confidence as to the designed, specific difference's contribution to deviation in performance between the test and control regions (e.g., based on a comparison of the fitness metric, F, to a defined threshold, etc.). In doing so, the potential confidence may represent a confidence in identification of the regions 302 as test regions, the regions 304 as control regions, etc. based on intended differences in planting, treatment, etc. between the regions (and not other, unintended or unforeseen differences).

What's more, it should be appreciated that the two identified regions, test and control, for example, may be defined in a variety of different ways in connection with generating the fitness metric, F. In the example of FIG. 3A, the regions are defined using one or more of the implementations above, in whole or in part. Alternatively, or additionally, the regions may be defined by treatment maps, soil maps, NDVI data for the field (or broadly, image data for the field), etc. Generally, the input data for determining the fitness metric(s) is sufficient to delineate two regions, whereby a fitness metric is provided as an indicator of the similarities of the two regions, at least from a distance, d, perspective.

With reference to again to Equation (1), w(d) represents a weighting function with respect to points p and q, which may be modified and/or expressed in various different manners. Such weighting function is provided to approximate the spatial autocorrelation of an experiment's target variable in the absence of an experiment (e.g., yield, etc.). As such, the fitness metric, F, may be based on more than mere distance in evaluating the regions. In one example, the weighting function, w(d), may be expressed exponentially, as provided below.

$$w ( d ) ∝ {e}^{\frac{- d}{20}}$$

Alternatively in Equation (1), the weighting function, w(d), may be expressed spherically, for example, as expressed below. While a size value of 40 is used below, it should be appreciated that other size values may be used, for example, more or less than 40, etc., in other embodiments.

$$w ( d ) ∝ \{ \begin{matrix}1 - 1.5 ( \frac{d}{40} ) + 0.5 {( \frac{d}{40} )}^{3} & , d < 40 \\ 0 & , d \geq 40\end{matrix} \begin{matrix} \\ \end{matrix}$$

As explained above, the distance between the different locations (p, q) of the trial, for example, forms the basis for the fitness metric. That said, it should be appreciated that the weighting function (w(d)) may be tuned and/or modified to model any other variations in the field 102, for example, from ground elevation to soil type to soil composition, etc. For example, the agricultural computer system 114 may be configured to select a specific weighting function, based on soil layer data for the field 102. More broadly, the weighting function may be imposed on the fitness metric to eliminate or limit confounding factors in the comparison of the two regions, for example, the test region and the control region.

In view of the above, the agricultural computer system 114 is configured to calculate a fitness metric for each of the locations in the region relative to the other region, and to calculate the aggregate fitness metric for the field 102, for example. The agricultural computer system 114 is further configured to store the metrics, as associated with the trials, in the data server 110.

In the example embodiment of FIG. 1, therefore, the agricultural computer system 114 is configured to identify desired regions (e.g., trials, etc.) in the field 102 for assessment (e.g., evaluation, comparison, analysis, review, etc.) and to then determine assessment metrics (e.g., fitness metrics, etc.) for regions. It should be appreciated that the agricultural computer system 114 may be further configured to provide the identified trials, associated data, and/or the assessment metrics for one or more specific regions (e.g., trials, etc.) to the grower 104, for example, through a mobile application such as CLIMATE FIELDVIEW®, which is commercially available from Climate LLC, Saint Louis, Missouri. as described herein.

In various embodiments, the agricultural computer system 114 may be configured to further define and/or refine the definition of the trial region, or boundary of the trial, based on the fitness metrics (broadly, assessment metrics). In particular, for example, the agricultural computer system 114 is configured to determine the fitness metric between two different regions in the field 102 (e.g., delineated by treated and untreated region, etc.), as explained above, whereby each location in the field is associated with a fitness metric (relative to location in the opposite region). Subsequently, for the field 102, for example, the agricultural computer system 114 is configured to scale the fitness metrics for the field 102, whereby the metrics are expressed consistent with a particular scale. For example, the agricultural computer system 114 may be configured to scale the fitness metrics from the field to a scale of 0 to 1.

Thereafter, the agricultural computer system 114 is configured to impose a threshold on the fitness metrics (e.g., between zero and one, between zero and one hundred, etc.), to delineate a sub-region of the field 102 where the relative fitness metrics satisfy the threshold. It should be appreciated that the threshold may be imposed, by the agricultural computer system 114, as a form of masking parts of the field 102 outside of the sub-region, or as a sub-field mask.

The agricultural computer system 114 may then be configured to manipulate the sub-region, to define the trial in the filed 102. In particular, in this example embodiment, the agricultural computer system 114 is configured to dilate and erode the sub-region, at one or more times, in succession. For example, the agricultural computer system 114 may be configured to dilate the sub-region by a distance d, and then erode the dilated sub-field by a distance of 2d, and then dilate the sub-field by a distance of d. Despite this specific example, it should be appreciated that other sequences of dilation and erosion may be employed in other example embodiments, or other relationships between dilation and erosion (e.g., other than d and 2d such as d and 1.5d, d and 3d, etc.; etc.), in order to manipulate the sub-region identified from the fitness metrics. In this manner, the manipulation of the sub-field, once identified, imposes a consolidation of the trial region in the field 102.

After manipulation of the sub-region, the agricultural computer system 114 is configured to identify a perimeter of the trial based on the remaining, or resulting sub-region.

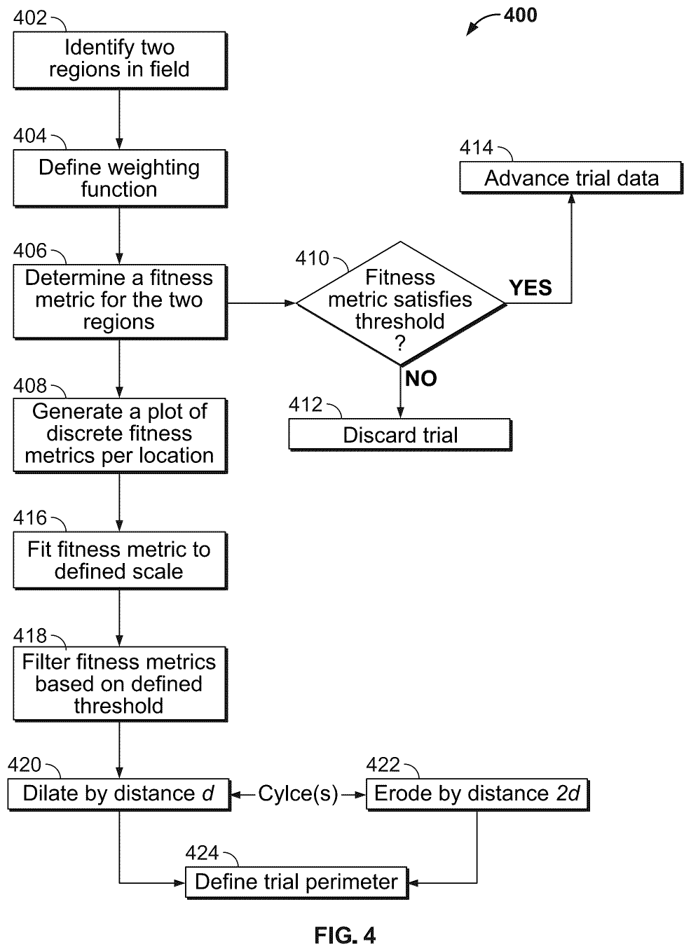

FIG. 4 illustrates an example method 400 for determining a fitness metric for a field, where the field includes two regions with a target disparate condition. The example method 400 is described herein in connection with the system 100, and may be implemented, in whole or in part, in the agricultural computer system 114 of the system 100. However, it should be appreciated that the method 400, or other methods described herein, are not limited to the system 100 or the agricultural computer system 114. And, conversely, the systems, data servers, and the computing devices described herein are not limited to the example method 400.

At the outset, it should be appreciated that data is stored in the data server 110 for the field 102, where the data is indicative of the features of the field 102 and prior use of the field 102 for planting, growing and harvesting of crops. In general, the data included in the data server 110 includes a target condition for the field 102, which is different between one region in the field 102 and another region in the field 102. In addition, the regions define specific geometries within the field 102. In connection therewith, the regions may be defined by the grower 104, for example, or another user, prior to initiating a trial based on the two regions, or the trial may be identified as described herein after planting and/or harvest, etc.

That said, in method 400, the agricultural computer system 114 identifies, at 402, the two regions of interest, which may be included in the same field 102, for example, or more generally, in a same growing space, etc. In this example, the two regions are located in the field 102, where the first region is a test region and the second region in a control region.

Next, at 404, the agricultural computer system 114 defines a weighting function, which is used in Equation (1) above to determine the fitness metric. The weighting function may be defined based on the characteristics of the field 102, for example, flat, uniform, hilly, disparate soil conditions/content, etc. To this point, the weighting function may be selected, determined, etc. to capture a spatial autocorrelation of a target variable for the field 102 (e.g., yield, etc.), in absence of an experimental treatment. As such, the weighting function may be viewed, for example, as an inverse of the approximate yield semivariogram. That said, while the weighting function may be generally selected as above, it should be appreciated that in some examples the selected weighting function may further be modified so that the experimental fitness of geometries of a given scale are emphasized and to improve identification of specific spatial experimental arrangements. For instance, in examples in which test strips are 30 m wide, the weighting function may include a piecewise function that is 1 for widths from 0 m to 30 m, and 0 for widths that are greater than 30 m. Here, such a weighting function generally emphasizes spatial features that have dimensions of 30 m or less.

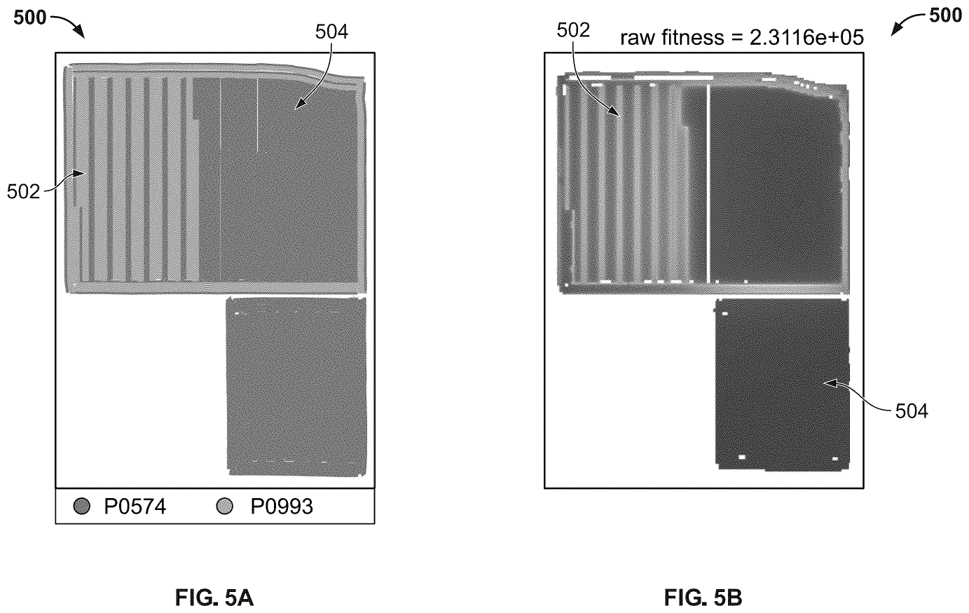

Next, the agricultural computer system 114 determines, at 406, the fitness metric for each cell or section within the two regions, based on the relative distance for each cell or location in one region to each other cell or location in the other region. These fitness metrics are then combined to provide a fitness metric for the field 102, based on Equation (1). The fitness metric, then, is specific to the two regions of the field 102. To this point, in the context of Equation (1), the above generally relates to continuous field data. And, to implement this, the integrals of Equation (1) are approximated by rasterizing the regions, and computing fitness values between individual pixels. The discrete fitness values are then summed while accounting for pixel areas. In method 400, the values are used to generate, at 408, a plot of the two regions, with the values represented by colors, shading, hatching, or otherwise. FIGS. 5A-5B illustrate a field 500, in which two regions 502, 504 are defined in FIG. 5A (in which the region 502 has a difference of interest from the region 504), and then in which the discrete fitness score/metric for each cell/location in the regions 502, 504 is shown in FIG. 5B.

Once the fitness metric is determined for the field 102, the agricultural computer system 114 determines, at 410, whether the fitness metric for the field 102 (e.g., for the two regions or treatment pair for which the fitness metric was determined, etc.) satisfies a threshold. In doing so, the threshold used may be based the fitness metric itself, or alternatively/additionally, on a fitness density for the field 102, for instance, which may be defined as F/A where A is a sum of area of the two treatment areas (e.g., thereby providing an average amount of experiment per unit area, etc.). Because the fitness metric is representative of the location similarity of the two regions, the fitness metric may be used to determine if there is sufficient location similarity to attribute confidence to any specific output of the trial for the target condition of the two regions. The threshold may be any suitable value, where satisfying the threshold provides the grower 104 or other user sufficient understanding and/or confidence in the similarity of the two regions to credit the result of the trial for the target condition. In method 500, when the threshold is not satisfied, the agricultural computer system 114 discards, at 412, the trial and/or data associated with the trial from further analysis and/or assessment (e.g., automatically, without additional input from the grower 104, etc.).

Conversely, when the threshold is satisfied, the agricultural computer system 114 advances, at 414, the data associated with the regions, or trial, for further analysis and/or assessment. This may include, for example, providing, by the agricultural computer system 114, results to the grower 104 through a mobile application such as CLIMATE FIELDVIEW®, from Climate LLC (Saint Louis, Missouri) or another associated and/or affiliated platform, or otherwise, etc. In doing so, the results may be displayed to the grower 104, for example, through the application (e.g., via device 116, etc.).

Notwithstanding the above, the fitness metric, by location or cell, may be used to assess the trial (or trials) in the field 102. As shown in FIG. 5A, for example, it is apparent that a trial is disposed in the upper left portion of the field, but not in the right portion of the field.

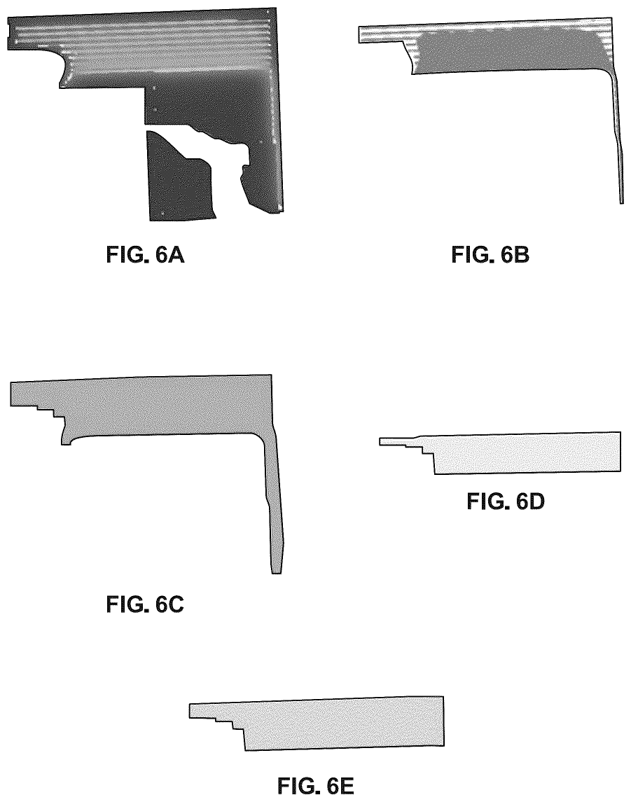

Specifically, with reference to FIG. 4, after generating the plot of discrete fitness metrics per location (or after generating the fitness metric per location), the agricultural computer system 114 may fit, at 416, the fitness metric(s) to a defined scale. For example, a defined scale may be 0 to 1 (or 0 to 10, or 0 to 100, or any other suitable scale, etc.), whereby each of the fitness metrics is fit to the defined scale, while the fitness metrics for the locations retain a relative value to one another. FIG. 6A includes a representation of the fitness metrics, according to the defined scale, where the fitness metrics are illustrated by color (or shading of colors, or darkness of shading, etc.). Next, in method 400, the agricultural computer system 114 may filter the fitness metrics, at 418, based on a defined threshold. The threshold, for a scale of 0 to 1, may include a value of 3 or 5, or more or less, etc., and the fitness metrics are then filtered out, per location, when the fitness metric at the location fails to exceed the defined threshold. As shown in FIG. 6A, in progressing from FIG. 6A to FIG. 6B, various fitness metrics are filtered out, which leaves a sub-region of the field 102, for example.

With reference again to FIG. 4, at 420, the agricultural computer system 114 then dilates the remaining locations by a distance d, which may include a number of feet (e.g., 10 feet, 50 feet, etc.). Consequently, the sub-region is expanded, as shown in progressing from FIG. 6B to FIG. 6C. Next, at 422 in the method 400, the agricultural computer system 114 erodes the dilated sub-region by a distance 2d, in this example. Consequently, the dilated sub-region is eroded, as shown in progressing from FIG. 6C to FIG. 6D. In this embodiment, the eroded sub-region is then dilated, again, at 424 in FIG. 4, whereby the sub-region is again expanded, as shown in progressing from FIG. 6D to FIG. 6E. Then, at 424, the agricultural computer system 114 defines a perimeter of the trial as the outer boundary of the dilated sub-region (e.g., as showing in FIG. 6E, etc.). It should be appreciated that a number of dilation and/or erosion cycles may be included in other embodiments, to, for example, improve the quality of the resulting boundary definition of the trial.

It should be appreciated that the boundary definition may be advanced along with the trial data, at 414, for further analysis and/or assessment.

Further, in one or more embodiments, the agricultural computer system 114 may further provide the identified trials and associated perimeter data or other associated data, and/or the assessment metrics for one or more specific regions (e.g., trials, etc.) to the grower 104, for example, through a mobile application such as CLIMATE FIELDVIEW®, which is commercially available from Climate LLC, Saint Louis, Missouri. as described herein.

With reference again to FIG. 1, the grower 104 in the system 100 may own, operate or possess a field manager computing device 116 in a field location, or associated with a field location, such as field 102, intended for agricultural activities or a management location for one or more agricultural fields. The field manager computing device 116 is programmed, or configured, to provide field data to the agricultural computer system 114 via one or more networks (as indicated by arrowed lines in FIG. 1) (e.g., for use in identifying characteristics of field 102, for use in identifying trials in the field 102, etc.). The field manager computing device 116 is also programmed, or configured, to receive data from the agricultural computer system 114, for example, the identified trial(s) described above, the fitness metric(s) described above, etc. The network(s) may each include, without limitation, one or more of a local area networks (LANs), wide area network (WANs) (e.g., the Internet, etc.), mobile/cellular networks, virtual networks, and/or another suitable public and/or private networks capable of supporting communication among parts of the system 100 illustrated in FIG. 1, or any combination thereof.

Examples of field data are provided above in connection with the description of the system 100. Additional examples may include, without limitation, (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), (k) soil, seed, crop phenology, pest and disease reporting, and predictions sources and databases, and (l) other data described herein, etc.

As described, data server 110 is communicatively coupled to the agricultural computer system 114 and is programmed, or configured, to send external data (e.g., data associated with fields, etc.) to and/or receive other data from (e.g., identification of trials, fitness metrics, etc.) agricultural computer system 114 via the network(s) herein (e.g., for use in identifying candidate seeds, treatments, etc. for the field 102 identified by the grower 104; for use in modifying such selections and/or identifications of seeds, treatments, etc.; etc.). The data server 110 may be owned or operated by the same legal person or entity as the agricultural computer system 114, or by a different person or entity, such as a government agency, non-governmental organization (NGO), and/or a private data service provider. Examples of external data include weather data, imagery data, soil data, seed data and seed selection data as described herein, data from the field 102, or statistical data relating to crop yields, among others. External data may include the same type of information as field data. In some embodiments, the external data may also be provided by data server 110 owned by the same entity that owns and/or operates the agricultural computer system 114. For example, the agricultural computer system 114 may include a data server focused exclusively on a type of data that might otherwise be obtained from third party sources, such as weather data. In some embodiments, data server 110 may actually be incorporated within the system 114.

The system 100 also includes, as described above, farm equipment (e.g., planter 106, harvester 108, a sprayer, etc.) configured to plant and harvest seeds from one or more growing spaces (e.g., from field 102, etc.) and provide treatments thereto, etc. In some examples, the farm equipment may have one or more remote sensors fixed thereon, where the sensor(s) are communicatively coupled, either directly or indirectly, via the farm equipment to the agricultural computer system 114 and are programmed, or configured, to send sensor data to agricultural computer system 114.

Notwithstanding the above, examples of agricultural apparatus that may be utilized in the system 100 (and in the field 102) include tractors, combines, other harvesters, planters, trucks, fertilizer equipment, aerial vehicles including unmanned aerial vehicles, and any other item of physical machinery or hardware, typically mobile machinery, and which may be used in tasks associated with agriculture and/or related to operations described herein. In some embodiments, a single unit of the agricultural apparatus may comprise a plurality of sensors that are coupled locally in a network on the apparatus. Controller area network (CAN) is an example of such a network that can be installed in combines, harvesters, sprayers, and cultivators. In connection therewith, then, an application controller associated with the apparatus may be communicatively coupled to agricultural computer system 114 via the network(s) and programmed, or configured, to receive one or more scripts that are used to control an operating parameter of the agricultural apparatus (or another agricultural vehicle or implement) from the agricultural computer system 114. For instance, a CAN bus interface may be used to enable communications from the agricultural computer system 114 to the agricultural apparatus, for example, such as how the CLIMATE FIELDVIEW® DRIVE, available from Climate LLC, Saint Louis, Missouri, is used. Sensor data may consist of the same type of information as field data. In some embodiments, remote sensors may not be fixed to an agricultural apparatus but may be remotely located in the field and may communicate with one or more networks of the system 100.

As indicated above, the network(s) of the system 100 are generally illustrated in FIG. 1 by arrowed lines. In connection therewith, the network(s) broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. For instance, the farm equipment in the system 100, data server 110, agricultural computer system 114, and other elements of the system 100 may each comprise an interface compatible with the network(s) and programmed, or configured, to use standardized protocols for communication across the networks, such as TCP/IP, Bluetooth, CAN protocol and higher-layer protocols, such as HTTP, TLS, and the like.

Agricultural computer system 114 is programmed, or configured, to receive field data from field manager computing device 116, external data from data server 110, and sensor data from one or more remote sensors in the system 100, and also to provide data to the field manager computing device 116. Agricultural computer system 114 may be further configured to host, use or execute one or more computer programs, other software elements, digitally programmed logic, such as FPGAs or ASICs, or any combination thereof to perform translation and storage of data values, construction of digital models of one or more crops on one or more fields, generation of recommendations and notifications, and generation and sending of scripts, in the manner described further in other sections of this disclosure.

In an embodiment, as shown in FIG. 1, for example, agricultural computer system 114 is programmed with or comprises a communication layer 118, a presentation layer 120, a data management layer 124, a hardware/virtualization layer 126, and a model and field data repository 128. “Layer,” in this context, refers to any combination of electronic digital interface circuits, microcontrollers, firmware, such as drivers, and/or computer programs, or other software elements.

Communication layer 118 may be programmed, or configured, to perform input/output interfacing functions including sending requests to field manager computing device 116, data server 110, and remote sensor(s) for field data, external data, and sensor data respectively. Communication layer 118 may be programmed, or configured, to send the received data to repository layer 128 to be stored as field data (e.g., in computer system 114, etc.).

Presentation layer 120 may be programmed, or configured, to generate a graphical user interface (GUI) to be displayed on field manager computing device 116 (e.g., for use in interacting with agricultural computer system 114 to identify the field 102 as a target field for application of the present disclosure, target seed, etc.) or other computers that are coupled to the system 114 through the network(s). The GUI may comprise controls for inputting data to be sent to agricultural computer system 114, generating requests for models and/or recommendations, and/or displaying recommendations, notifications, models, and other field data.

Data management layer 124 may be programmed, or configured, to manage read operations and write operations involving the repository layer 128 and other functional elements of the system, including queries and result sets communicated between the functional elements of the system and the repository. Examples of data management layer 124 include JDBC, SQL server interface code, and/or HADOOP interface code, among others. Repository layer 128 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases.

However, any database may be used that enables the systems and methods described herein. When field data is not provided directly to the agricultural computer system 114 via one or more agricultural machines or agricultural machine devices that interact with the agricultural computer system 114, the grower 104 may be prompted via one or more user interfaces on the device 116 (served by the agricultural computer system 114) to input such information for use in effecting the selections herein. In an example embodiment, the grower 104 may specify identification data by accessing a map on the device 116 (served by the agricultural computer system 114) and selecting specific CLUs that have been graphically shown on the map. In an alternative embodiment, the grower 104 may specify identification data by accessing a map on the device 116 (served by the agricultural computer system 114) and drawing boundaries of the field over the map. Such CLU selection, or map drawings, represent geographic identifiers. In alternative embodiments, the grower 104 may specify identification data by accessing field identification data (provided as shape files or in a similar format) from the U.S. Department of Agriculture Farm Service Agency, or other source, via the device 116 and providing such field identification data to the agricultural computer system 114.

In an example embodiment, the agricultural computer system 114 is programmed to generate and cause displaying of a graphical user interface comprising a data manager for data input. After one or more fields (and/or trials) have been identified using the methods described above, the data manager may provide one or more graphical user interface widgets which when selected can identify changes to the field, soil, crops, tillage, nutrient practices, and/or which may provide comparison data related to target seed identified by the grower 104 and candidate seeds identified by the disclosure herein for the field 102. The data manager may include a timeline view, a spreadsheet view, a graphical view, and/or one or more editable programs.

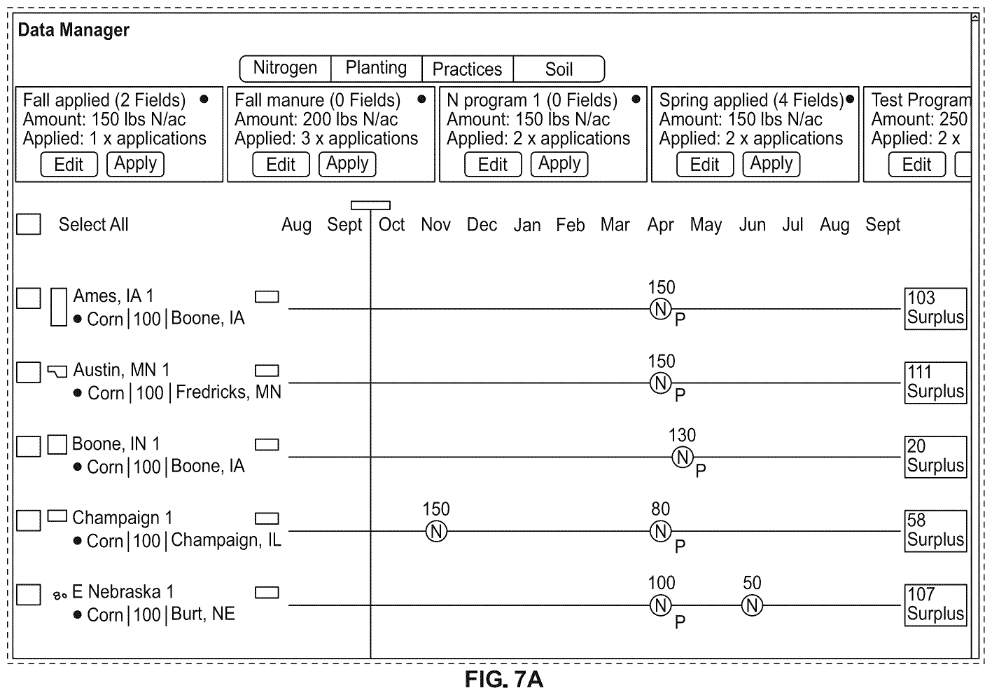

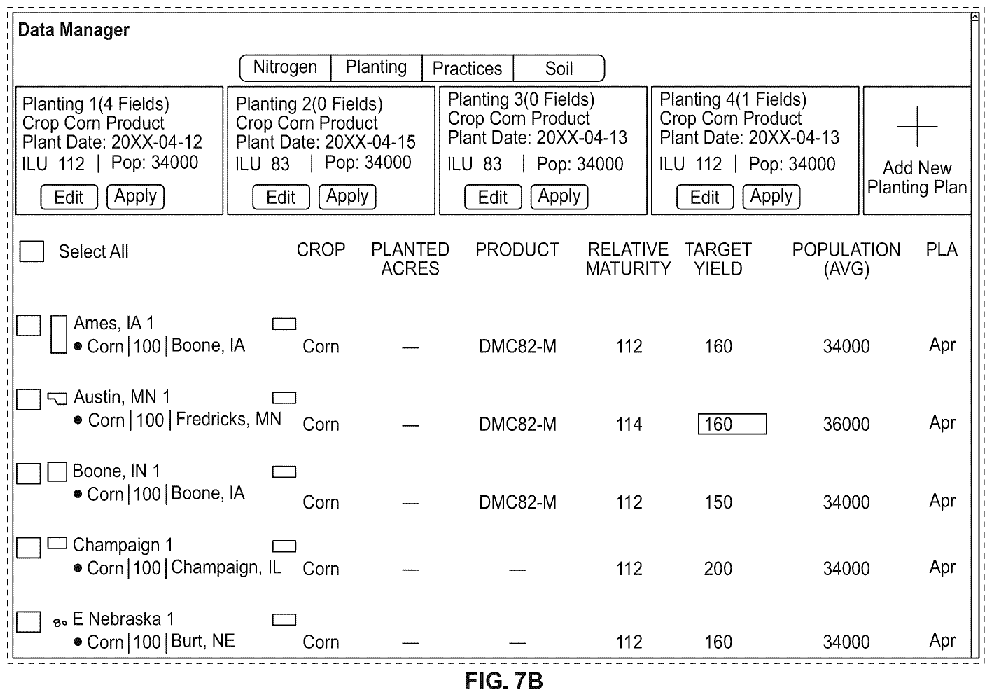

FIG. 7A depicts an example embodiment of a timeline view for data entry. Using the display depicted in FIG. 7A, a user computer can input a selection of a particular field and a particular date for the addition of events (e.g., treatments, etc.). Events depicted at the top of the timeline may include Nitrogen, Planting, Practices, and Soil. To add a nitrogen application event, a user computer may provide input to select the nitrogen tab. The user computer may then select a location on the timeline for a particular field in order to indicate an application of nitrogen on the selected field. In response to receiving a selection of a location on the timeline for a particular field, the data manager may display a data entry overlay, allowing the user computer to input data pertaining to nitrogen applications, planting procedures, soil application, tillage procedures, irrigation practices, or other information relating to the particular field. For example, if a user computer selects a portion of the timeline and indicates an application of nitrogen, then the data entry overlay may include fields for inputting an amount of nitrogen applied, a date of application, a type of fertilizer used, and any other information related to the application of nitrogen.

In an embodiment, the data manager 124 provides an interface for creating one or more programs. “Program,” in this context, refers to a set of data pertaining to nitrogen applications, planting procedures, soil application, tillage procedures, irrigation practices, or other information that may be related to one or more fields, and that can be stored in digital data storage for reuse as a set in other operations. After a program has been created, it may be conceptually applied to one or more fields and references to the program may be stored in digital storage in association with data identifying the fields. Thus, instead of manually entering identical data relating to the same nitrogen applications for multiple different fields, a user computer may create a program that indicates a particular application of nitrogen and then apply the program to multiple different fields. For example, in the timeline view of FIG. 7A, the top two timelines have the “Spring applied” program selected, which includes an application of 150 lbs N/ac in early April. The data manager may provide an interface for editing a program. In an embodiment, when a particular program is edited, each field that has selected the particular program is edited. For example, in FIG. 7A, if the “Spring applied” program is edited to reduce the application of nitrogen to 116 lbs N/ac, the top two fields may be updated with a reduced application of nitrogen based on the edited program.

In an embodiment, in response to receiving edits to a field that has a program selected, the data manager removes the correspondence of the field to the selected program. For example, if a nitrogen application is added to the field in FIG. 7A, the interface may update to indicate that the “Spring applied” program is no longer being applied to the top field. While the nitrogen application in early April may remain, updates to the “Spring applied” program would not alter the April application of nitrogen.

FIG. 7B depicts an example embodiment of a spreadsheet view for data entry. Using the display depicted in FIG. 7B, a user can create and edit information for one or more fields. The data manager may include spreadsheets for inputting information with respect to Nitrogen, Planting, Practices, and Soil as depicted in FIG. 7B. To edit a particular entry, a user computer may select the particular entry in the spreadsheet and update the values. For example, FIG. 7B depicts an in-progress update to a target yield value for the second field. Additionally, a user computer may select one or more fields in order to apply one or more programs. In response to receiving a selection of a program for a particular field, the data manager may automatically complete the entries for the particular field based on the selected program. As with the timeline view, the data manager may update the entries for each field associated with a particular program in response to receiving an update to the program. Additionally, the data manager may remove the correspondence of the selected program to the field in response to receiving an edit to one of the entries for the field.

In an embodiment, model and field data is stored in data repository layer 128. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

With reference again to FIG. 1, in an embodiment, instructions 122 of the agricultural computer system 114 may comprise a set of one or more pages of main memory, such as RAM, in the agricultural computer system 114 into which executable instructions have been loaded and which when executed cause the agricultural computer system 114 to perform the functions or operations that are described herein. For example, the instructions 122 may comprise a set of pages in RAM that contain instructions which, when executed, cause performing the seed identification functions described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions 122 also may represent one or more files or projects of source code that are digitally stored in a mass storage device, such as non-volatile RAM or disk storage, in the agricultural computer system 114 or a separate repository system, which when compiled or interpreted cause generating executable instructions which when executed cause the agricultural computer system 114 to perform the functions or operations that are described herein. In other words, the drawing figure may represent the manner in which programmers or software developers organize and arrange source code for later compilation into an executable, or interpretation into bytecode or the equivalent, for execution by the agricultural computer system 114.

Hardware/virtualization layer 126 comprises one or more central processing units (CPUs), memory controllers, and other devices, components, or elements of a computer system, such as volatile or non-volatile memory, non-volatile storage, such as disk, and I/O devices or interfaces as illustrated and described herein. The layer 126 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices 116 associated with different users. Further, the system 114 and/or data server 110 may be implemented using two or more processors, cores, clusters, or instances of physical machines or virtual machines, configured in a discrete location or co-located with other elements in a datacenter, shared computing facility or cloud computing facility.

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an embodiment, grower 104 interacts with agricultural computer system 114 using field manager computing device 116 configured with an operating system and one or more application programs or apps; the field manager computing device 116 also may interoperate with the agricultural computer system 114 independently and automatically under program control or logical control and direct user interaction is not always required. Field manager computing device 116 broadly represents one or more of a smart phone, PDA, tablet computing device, laptop computer, desktop computer, workstation, or any other computing device capable of transmitting and receiving information and performing the functions described herein. Field manager computing device 116 may communicate via a network using a mobile application stored on field manager computing device 116, and in some embodiments, the device may be coupled using a cable or connector to one or more sensors and/or other apparatus in the system 100. A particular grower 104 may own, operate or possess and use, in connection with system 100, more than one field manager computing device 116 at a time.

The mobile application associated with the field manager computing device 116 may provide client-side functionality, via the network to one or more mobile computing devices. In an example embodiment, field manager computing device 116 may access the mobile application via a web browser or a local client application or app. Field manager computing device 116 may transmit data to, and receive data from, one or more front-end servers, using web-based protocols, or formats, such as HTTP, XML and/or JSON, or app-specific protocols. In an example embodiment, the data may take the form of requests and user information input, such as field data, into the mobile computing device. In some embodiments, the mobile application interacts with location tracking hardware and software on field manager computing device 116 which determines the location of field manager computing device 116 using standard tracking techniques, such as multilateration of radio signals, the global positioning system (GPS), WiFi positioning systems, or other methods of mobile positioning. In some cases, location data or other data associated with the device 116, grower 104, and/or user account(s) may be obtained by queries to an operating system of the device or by requesting an app on the device to obtain data from the operating system.

In an embodiment, in addition to other functionalities described herein, field manager computing device 116 sends field data (or other data) to agricultural computer system 114 comprising or including, but not limited to, data values representing one or more of: a geographical location of the one or more fields, tillage information for the one or more fields, crops planted in the one or more fields, and soil data extracted from the one or more fields. Field manager computing device 116 may send field data in response to user input from grower 104 specifying the data values for the one or more fields. Additionally, field manager computing device 116 may automatically send field data when one or more of the data values becomes available to field manager computing device 116. For example, field manager computing device 116 may be communicatively coupled to a remote sensor in the system 100, and in response to an input received at the sensor, field manager computing device 116 may send field data to agricultural computer system 114 representative of the input. Field data identified in this disclosure may be input and communicated using electronic digital data that is communicated between computing devices using parameterized URLs over HTTP, or another suitable communication or messaging protocol. In that sense, in some aspects of the present disclosure, the field data provided by the field manager computing device 116 may also be stored as external data (e.g., where the field data is collected as part of harvesting crops from the field 102, etc.), for example, in data server 110.

A commercial example of the mobile application is CLIMATE FIELDVIEW®, commercially available from Climate LLC, Saint Louis, Missouri. The CLIMATE FIELDVIEW® application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

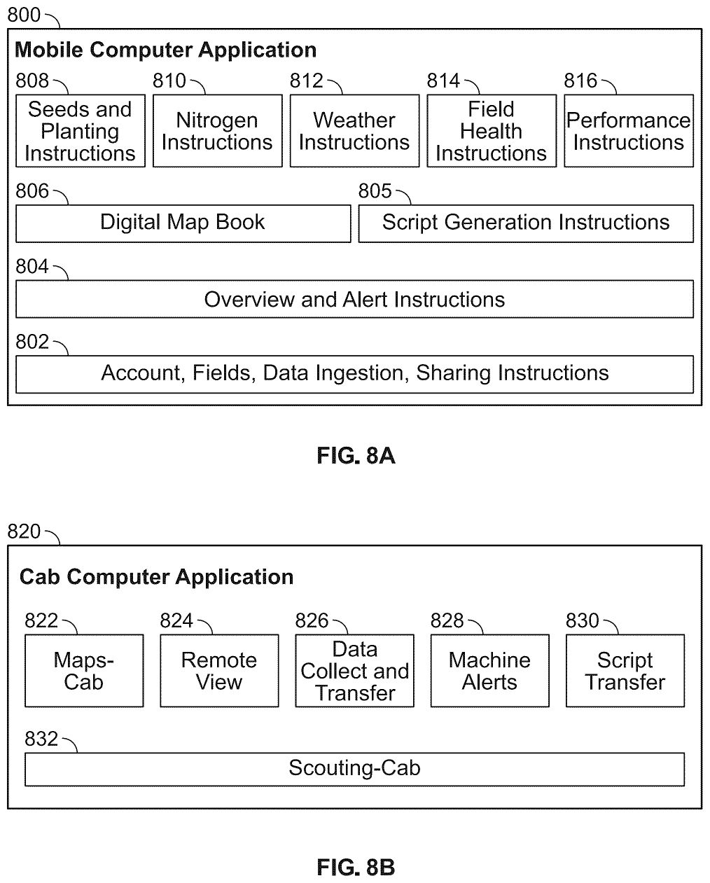

FIGS. 8A-8B illustrate two views of an example logical organization of sets of instructions in main memory when an example mobile application is loaded for execution. Each named element represents a region of one or more pages of RAM or other main memory, or one or more blocks of disk storage or other non-volatile storage, and the programmed instructions within those regions. In one embodiment, in FIG. 8A, a mobile computer application 800 comprises account-fields-data ingestion-sharing instructions 802, overview and alert instructions 804, digital map book instructions 806, seeds and planting instructions 808, nitrogen instructions 810, weather instructions 812, field health instructions 814, and performance instructions 816.

In one embodiment, a mobile computer application 800 comprises account, fields, data ingestion, sharing instructions 802 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 800 comprises a data inbox. In response to receiving a selection of the data inbox, the mobile computer application 800 may display a graphical user interface for manually uploading data files and importing uploaded files to a data manager.

In one embodiment, digital map book instructions 806 comprise field map data layers stored in device memory and are programmed with data visualization tools and geospatial field notes. This provides growers with convenient information close at hand for reference, logging and visual insights into field performance. In one embodiment, overview and alert instructions 804 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 808 are programmed to provide tools for seed selection, hybrid placement, and script creation, including variable rate (VR) script creation, based upon scientific models and empirical data. This enables growers to maximize yield or return on investment through optimized seed purchase, placement and population.

In one embodiment, script generation instructions 805 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 800 may display one or more fields broken into management zones, such as the field map data layers created as part of digital map book instructions 806. In one embodiment, the management zones comprise soil zones along with a panel identifying each soil zone and a soil name, texture, drainage for each zone, or other field data. Mobile computer application 800 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 800 may make the script available for download in a format readable by an application controller, such as an archived or compressed format. Additionally, and/or alternatively, a script may be sent directly to a cab computer (e.g., associated with planter 106, harvester 108, etc.) from mobile computer application 800 and/or uploaded to one or more data servers and stored for further use.

In one embodiment, nitrogen instructions 810 are programmed to provide tools to inform nitrogen decisions by visualizing the availability of nitrogen to crops. This enables growers to maximize yield or return on investment through optimized nitrogen application during the season. Example programmed functions include displaying images, such as SSURGO images, to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others. “Mass data entry,” in this context, may mean entering data once and then applying the same data to multiple fields and/or zones that have been defined in the system; example data may include nitrogen application data that is the same for many fields and/or zones of the same grower, but such mass data entry applies to the entry of any type of field data into the mobile computer application 800. For example, nitrogen instructions 810 may be programmed to accept definitions of nitrogen application and practices programs and to accept user input specifying to apply those programs across multiple fields. “Nitrogen application programs,” in this context, refers to stored, named sets of data that associates: a name, color code or other identifier, one or more dates of application, types of material or product for each of the dates and amounts, method of application or incorporation, such as injected or broadcast, and/or amounts or rates of application for each of the dates, crop or hybrid that is the subject of the application, among others. “Nitrogen practices programs,” in this context, refer to stored, named sets of data that associates: a practices name; a previous crop; a tillage system; a date of primarily tillage; one or more previous tillage systems that were used; one or more indicators of application type, such as manure, that were used. Nitrogen instructions 810 also may be programmed to generate and cause displaying a nitrogen graph, which indicates projections of plant use of the specified nitrogen and whether a surplus or shortfall is predicted; in some embodiments, different color indicators may signal a magnitude of surplus or magnitude of shortfall. In one embodiment, a nitrogen graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each nitrogen application and amount at points correlated to month names; and numeric and/or colored indicators of surplus or shortfall, in which color indicates magnitude.

In one embodiment, the nitrogen graph may include one or more user input features, such as dials or slider bars, to dynamically change the nitrogen planting and practices programs so that a user may optimize his nitrogen graph. The user may then use his optimized nitrogen graph and the related nitrogen planting and practices programs to implement one or more scripts, including variable rate (VR) fertility scripts. Nitrogen instructions 810 also may be programmed to generate and cause displaying a nitrogen map, which indicates projections of plant use of the specified nitrogen and whether a surplus or shortfall is predicted; in some embodiments, different color indicators may signal a magnitude of surplus or magnitude of shortfall. The nitrogen map may display projections of plant use of the specified nitrogen and whether a surplus or shortfall is predicted for different times in the past and the future (such as daily, weekly, monthly or yearly) using numeric and/or colored indicators of surplus or shortfall, in which color indicates magnitude. In one embodiment, the nitrogen map may include one or more user input features, such as dials or slider bars, to dynamically change the nitrogen planting and practices programs so that a user may optimize his nitrogen map, such as to obtain a preferred amount of surplus to shortfall. The user may then use his optimized nitrogen map and the related nitrogen planting and practices programs to implement one or more scripts, including variable rate (VR) fertility scripts. In other embodiments, similar instructions to the nitrogen instructions 810 could be used for application of other nutrients (such as phosphorus and potassium), application of pesticide, and irrigation programs.

In one embodiment, weather instructions 812 are programmed to provide field-specific recent weather data and forecasted weather information. This enables growers to save time and have an efficient integrated display with respect to daily operational decisions.

In one embodiment, field health instructions 814 are programmed to provide timely remote sensing images highlighting in-season crop variation and potential concerns. Example programmed functions include cloud checking, to identify possible clouds or cloud shadows; determining nitrogen indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 816 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 816 may be programmed to communicate via the network(s) to back-end analytics programs executed at agricultural computer system 114 and/or data server 110 and configured to analyze metrics, such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of a cab computer (e.g., associated with planter 106, harvester 108, etc.). For example, referring now to FIG. 8B, in one embodiment a cab computer application 820 (e.g., as accessible in planter 106, harvester 108, etc., etc.) may comprise maps-cab instructions 822, remote view instructions 824, data collect and transfer instructions 826, machine alerts instructions 828, script transfer instructions 830, and scouting-cab instructions 832. The code base for the instructions of FIG. 8B may be the same as for FIG. 8A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 822 may be programmed to provide map views of fields, farms or regions that are useful in directing machine operation. The remote view instructions 824 may be programmed to turn on, manage, and provide views of machine activity in real-time or near real-time to other computing devices connected to the computer system 114 via wireless networks, wired connectors or adapters, and the like. The data collect and transfer instructions 826 may be programmed to turn on, manage, and provide transfer of data collected at sensors and controllers to the computer system 114 via wireless networks, wired connectors or adapters, and the like (e.g., via network(s) in the system 100, etc.). The machine alerts instructions 828 may be programmed to detect issues with operations of the machine or tools that are associated with the cab and generate operator alerts. The script transfer instructions 830 may be configured to transfer in scripts of instructions that are configured to direct machine operations or the collection of data. The scouting-cab instructions 832 may be programmed to display location-based alerts and information received from the computer system 114 based on the location of the field manager computing device 116, farm equipment, or sensors in the field 102 and ingest, manage, and provide transfer of location-based scouting observations to the computer system 114 based on the location of the farm equipment or sensors in the field 102.

In an embodiment, data server 110 stores external data, including soil data representing soil composition for the one or more fields and weather data representing temperature and precipitation on the one or more fields. The weather data may include past and present weather data as well as forecasts for future weather data. In an embodiment, data server 110 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil. Further, in some embodiments, the data server 110, again, may include data associated with the field 102 with regard to available seeds for use in comparisons, etc.

In an embodiment, remote sensors in the system 100 may comprises one or more sensors that are programmed, or configured, to produce one or more observations. Remote sensor may be aerial sensors, such as satellites, vehicle sensors, planting equipment sensors, tillage sensors, fertilizer or insecticide application sensors, harvester sensors, and any other implement capable of receiving data from the one or more fields (e.g., field 102, etc.). In an embodiment, farm equipment may include an application controller programmed, or configured, to receive instructions from agricultural computer system 114. The application controller may also be programmed, or configured, to control an operating parameter of the farm equipment. Other embodiments may use any combination of sensors and controllers, of which the following are merely selected examples.

The system 100 may obtain or ingest data under grower 104 control, on a mass basis from a large number of growers who have contributed data to a shared database system. This form of obtaining data may be termed “manual data ingest” as one or more user-controlled computer operations are requested, or triggered, to obtain data for use by the computer system 114. As an example, the CLIMATE FIELDVIEW® application, commercially available from Climate LLC, Saint Louis, Missouri, may be operated to export data to computer system 114 for storing in the repository layer 128.

For example, seed monitor systems can both control planter apparatus components and obtain planting data, including signals from seed sensors via a signal harness that comprises a CAN backbone and point-to-point connections for registration and/or diagnostics. Seed monitor systems can be programmed, or configured, to display seed spacing, population and other information to the user via a cab computer of the apparatus, or other devices within the system 100. Examples are disclosed in U.S. Pat. No. 8,738,243 and US Pat. Pub. 20126094916, and the present disclosure assumes knowledge of those other patent disclosures.

Likewise, yield monitor systems may contain yield sensors for harvester apparatus that send yield measurement data to a cab computer of the apparatus, or other devices within the system 100. Yield monitor systems may utilize one or more remote sensors to obtain grain moisture measurements in a combine, or other harvester, and transmit these measurements to the user via the cab computer, or other devices within the system 100.

In an embodiment, examples of sensors that may be used with any moving vehicle, or apparatus of the type described elsewhere herein, include kinematic sensors and position sensors. Kinematic sensors may comprise any of speed sensors, such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors that may be used with tractors, or other moving vehicles, include engine speed sensors, fuel consumption sensors, area counters or distance counters that interact with GPS or radar signals, PTO (power take-off) speed sensors, tractor hydraulics sensors configured to detect hydraulics parameters, such as pressure or flow, and/or and hydraulic pump speed, wheel speed sensors or wheel slippage sensors. In an embodiment, examples of controllers that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors that may be used with seed planting equipment, such as planters, drills, or air seeders include seed sensors, which may be optical, electromagnetic, or impact sensors; downforce sensors, such as load pins, load cells, pressure sensors; soil property sensors, such as reflectivity sensors, moisture sensors, electrical conductivity sensors, optical residue sensors, or temperature sensors; component operating criteria sensors, such as planting depth sensors, downforce cylinder pressure sensors, seed disc speed sensors, seed drive motor encoders, seed conveyor system speed sensors, or vacuum level sensors; or pesticide application sensors, such as optical or other electromagnetic sensors, or impact sensors. In an embodiment, examples of controllers that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors that may be used with tillage equipment include position sensors for tools, such as shanks or discs; tool position sensors for such tools that are configured to detect depth, gang angle, or lateral spacing; downforce sensors; or draft force sensors. In an embodiment, examples of controllers that may be used with tillage equipment include downforce controllers or tool position controllers, such as controllers configured to control tool depth, gang angle, or lateral spacing.

In an embodiment, examples of sensors that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors, such as accelerometers disposed on sprayer booms. In an embodiment, examples of controllers that may be used with such apparatus include pump speed controllers; valve controllers that are programmed to control pressure, flow, direction, PWM and the like; or position actuators, such as for boom height, subsoiler depth, or boom position.

In an embodiment, examples of sensors that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors, such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers that may be used with harvesters include header operating criteria controllers for elements, such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors that may be used with grain carts include weight sensors, or sensors for auger position, operation, or speed. In an embodiment, examples of controllers that may be used with grain carts include controllers for auger position, operation, or speed.

In an embodiment, examples of sensors and controllers may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors. Examples are disclosed in U.S. patent application Ser. No. 14/831,165 and the present disclosure assumes knowledge of that other patent disclosures.

In an embodiment, sensors and controllers may be affixed to soil sampling and measurement apparatus that is configured, or programmed, to sample soil and perform soil chemistry tests, soil moisture tests, and other tests pertaining to soil. For example, the apparatus disclosed in U.S. Pat. Nos. 8,767,194 and 8,712,148 may be used, and the present disclosure assumes knowledge of those patent disclosures.

In an embodiment, sensors and controllers may comprise weather devices for monitoring weather conditions of fields. For example, the apparatus disclosed in published international application WO2016/176355A1, may be used, and the present disclosure assumes knowledge of that patent disclosure.

In an embodiment, the agricultural computer system 114 is programmed, or configured, to create an agronomic model. In this context, an agronomic model is a data structure in memory of the agricultural computer system 114 that comprises field data, such as identification data and harvest data for one or more fields. The agronomic model may also comprise calculated agronomic properties which describe either conditions which may affect the growth of one or more crops on a field, or properties of the one or more crops, or both. Additionally, an agronomic model may comprise recommendations based on agronomic factors, such as crop recommendations, irrigation recommendations, planting recommendations, fertilizer recommendations, fungicide recommendations, pesticide recommendations, harvesting recommendations and other crop management recommendations. The agronomic factors may also be used to estimate one or more crop related results, such as agronomic yield. The agronomic yield of a crop is an estimate of quantity of the crop that is produced, or in some examples, the revenue or profit obtained from the produced crop.

In an embodiment, the agricultural computer system 114 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truthing that compares predicted results with actual results on a field, such as a comparison of precipitation estimate with a rain gauge or sensor providing weather data at the same or nearby location or an estimate of nitrogen content with a soil sample measurement.

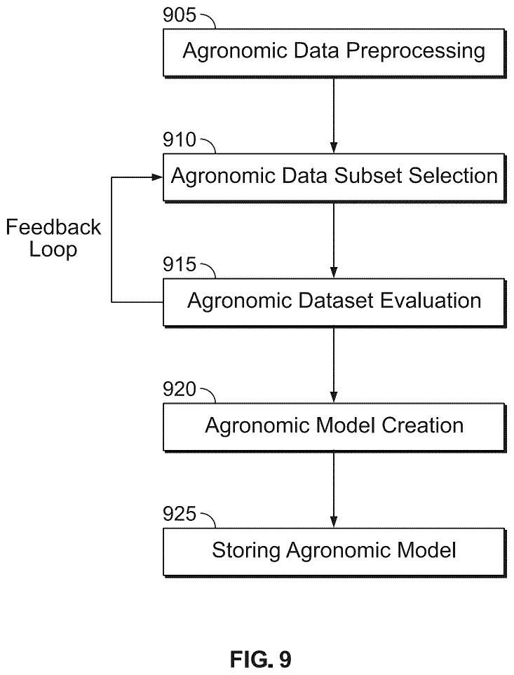

FIG. 9 illustrates a programmed process by which the agricultural computer system 114 generates one or more preconfigured agronomic models using field data provided by one or more data sources. FIG. 9 may serve as an algorithm or instructions for programming the functional elements of the agricultural computer system 114 to perform the operations that are now described.

At block 905, the agricultural computer system 114 is configured, or programmed, to implement agronomic data preprocessing of field data received from one or more data sources. The field data received from one or more data sources may be preprocessed for the purpose of removing noise, distorting effects, and confounding factors within the agronomic data including measured outliers that could adversely affect received field data values. Embodiments of agronomic data preprocessing may include, but are not limited to, removing data values commonly associated with outlier data values, specific measured data points that are known to unnecessarily skew other data values, data smoothing, aggregation, or sampling techniques used to remove or reduce additive or multiplicative effects from noise, and other filtering or data derivation techniques used to provide clear distinctions between positive and negative data inputs.

At block 910, the agricultural computer system 114 is configured, or programmed, to perform data subset selection using the preprocessed field data in order to identify datasets useful for initial agronomic model generation. The agricultural computer system 114 may implement data subset selection techniques including, but not limited to, a genetic algorithm method, an all subset models method, a sequential search method, a stepwise regression method, a particle swarm optimization method, and an ant colony optimization method. For example, a genetic algorithm selection technique uses an adaptive heuristic search algorithm, based on evolutionary principles of natural selection and genetics, to determine and evaluate datasets within the preprocessed agronomic data.

At block 915, the agricultural computer system 114 is configured, or programmed, to implement field dataset evaluation. In an embodiment, a specific field dataset is evaluated by creating an agronomic model and using specific quality thresholds for the created agronomic model. Agronomic models may be compared and/or validated using one or more comparison techniques, such as, but not limited to, root mean square error with leave-one-out cross validation (RMSECV), mean absolute error, and mean percentage error. For example, RMSECV can cross validate agronomic models by comparing predicted agronomic property values created by the agronomic model against historical agronomic property values collected and analyzed. In an embodiment, the agronomic dataset evaluation logic is used as a feedback loop where agronomic datasets that do not meet configured quality thresholds are used during future data subset selection steps (block 910).

At block 920, the agricultural computer system 114 is configured, or programmed, to implement agronomic model creation based upon the cross validated agronomic datasets. In an embodiment, agronomic model creation may implement multivariate regression techniques to create preconfigured agronomic data models.

At block 925, the agricultural computer system 114 is configured, or programmed, to store the preconfigured agronomic data models for future field data evaluation.

According to one embodiment, the techniques described herein are implemented by one or more special-purpose computing devices. The special-purpose computing devices may be hard-wired to perform the techniques, or may include digital electronic devices, such as one or more application-specific integrated circuits (ASICs) or field programmable gate arrays (FPGAs), that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

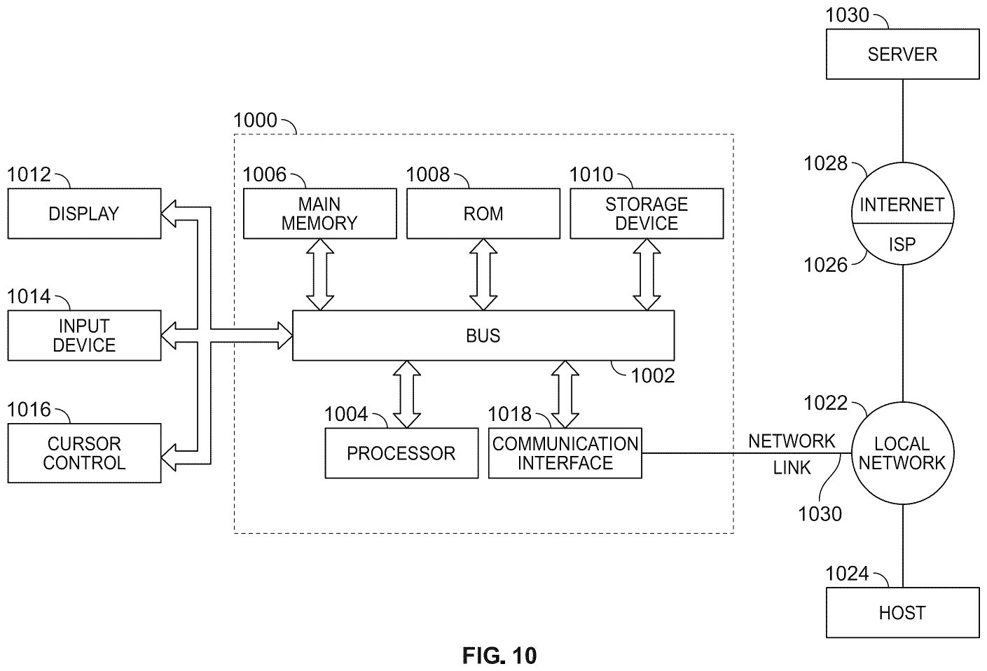

For example, FIG. 10 is a block diagram that illustrates a computer system 1000 upon which embodiments of the present disclosure may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008, or other static storage device coupled to bus 1002, for storing static information and instructions for processor 1004. A storage device 1010, such as a magnetic disk, optical disk, or solid-state drive, is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x, etc.) and a second axis (e.g., y, etc.), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of, or in combination with, software instructions.

The term “storage media” as used herein refers to any non-transitory media that stores data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from, but may be used in conjunction with, transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infrared data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infrared signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) identifying, by a computing device, two regions in a field for assessment, at least one of the two regions associated with an agricultural trial in the field; generating, by the computing device, an aggregate fitness metric for the two regions, the aggregate fitness metric indicative of a similarity between the two regions in the field; determining, by the computing device, whether the aggregate fitness metric satisfies a defined threshold; and automatically discarding, by the computing device, the trial in response to the determination that the aggregate fitness metric fails to satisfy the defined threshold.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in assessing one or more agricultural trials in a field, the method comprising:
identifying, by an agricultural computer system, two regions in a field for assessment, at least one of the two regions associated with an agricultural trial in the field;
generating, by the agricultural computer system, an aggregate fitness metric for the two regions, the aggregate fitness metric indicative of a similarity between the two regions in the field;
determining, by the agricultural computer system, whether the aggregate fitness metric satisfies a defined threshold; and
automatically discarding, by the agricultural computer system, the trial in response to the determination that the aggregate fitness metric fails to satisfy the defined threshold.

2. The method of claim 1, wherein the two regions include a first control region of the field and a second test region of the field.

3. The method of claim 2, wherein the first and second regions are part of the agricultural trial.

4. The method of claim 1, wherein a first region of the two regions includes at least one feature, and where a second region of the two regions excludes the at least one feature.

5. The method of claim 4, wherein the at least one feature includes one or more of seed type, field treatment, irrigation application, and soil type.

6. The method of claim 4, wherein generating the aggregate fitness metric includes:
computing, by the agricultural computer system, a fitness metric for each location of multiple locations in the first region, based on a distance between the location in the first region and each location in the second region; and
aggregating, by the agricultural computer system, each of the computed fitness metrics.

7. The method of claim 6, wherein computing the fitness metric for each location of the multiple locations in the first region includes determining the fitness metric consistent with:
$$F = {\int }_{p ∈ S , q ∈ U} … \int ( w ( d ( p , q ) ) dpdq ;$$
$$wherein :$$
$$d = \sqrt{{\sum }_{i = 1 to n} {( {p}_{i} - {q}_{i} )}^{2}} ;$$
and
wherein F represents the fitness metric, S and U represent the first and second regions, p and q represent points within the first and second regions, w(d) represents a weighting function with respect to points p and q, and d represents a Euclidean distance between the points p and q.

8. The method of claim 7, further comprising storing, by the agricultural computer system, the aggregate fitness metric and/or the computed fitness metric per location in one or more data structures; and
wherein the one or more data structures are included in the agricultural computer system or a separate computer system.

9. The method of claim 1, further comprising defining a weighting function indicative of one or more characteristics of the field; and
wherein the aggregate fitness metric is based on the weighting function.

10. The method of claim 9, wherein the weighting function is defined as:
$$w ( d ) ∝ {e}^{\frac{- d}{20}} ;$$
and/or
wherein the weighting function is defined based on elevation and/or soil composition/type disparity across the field.

11. The method of claim 1, further comprising generating a plot of the fitness metric for the field per location of a first region of the two regions and/or a second regions o the two regions.

12. The method of claim 11, wherein the plot includes one or more visual distinctions indicative of the fitness metric, the visual distinction including one or more of color, shading, hatching, or shape.

13. A system for use in assessing trials in fields, the system comprising an agricultural computer system, which is configured, by executable instructions, to:
identify two regions in a field for assessment, at least one of the two regions associated with an agricultural trial in the field; and
generate a fitness metric for each of a plurality of locations of the two regions, the fitness metric indicative of a distance between the locations in one of the two regions and each of multiple locations in the other of the two regions in the field.

14. The system of claim 13, wherein the agricultural computer system is further configured, by executable instructions, to:
filter out ones of the fitness metrics below a defined threshold;
dilate a boundary defined by remaining ones of the plurality of locations, by a distance d;
erode the dilated boundary by a multiple of the distance d; and then,
dilate the eroded boundary by the distance d; and
define the dilated boundary as a perimeter of the agricultural trial in the field.

15. The system of claim 14, wherein the agricultural computer system is further configured, by executable instructions, to fit the fitness metrics to a defined scale, prior to filtering the ones of the fitness metrics.

16. The system of claim 15, wherein the agricultural computer system is further configured, by executable instructions, to advance data associated with the trial along with a defined perimeter of the trial for further processing.

17. A non-transitory computer-readable storage medium comprising executable instructions for assessing a trial in a field, which when executed by at least one processor, cause the at least one processor to:
identify two regions in a field for assessment, at least one of the two regions associated with an agricultural trial in the field;
generate an aggregate fitness metric for the two regions, the aggregate fitness metric indicative of a similarity between the two regions in the field;
determine whether the aggregate fitness metric satisfies a defined threshold; and
automatically discard the trial in response to the determination that the aggregate fitness metric fails to satisfy the defined threshold.

18. The non-transitory computer-readable storage medium of claim 17, wherein the two regions include a first control region of the field excluding at least one feature and a second test region of the field including the at least one feature; and
wherein the first and second regions are part of the agricultural trial; and
wherein the at least one feature includes one or more of seed type, field treatment, irrigation application, and soil type.

19. The non-transitory computer-readable storage medium of claim 18, the executable instructions, when executed by at least one processor, cause the at least one processor to:
compute a fitness metric for each location of multiple locations in the first region, based on a distance between the location in the first region and each location in the second region; and
aggregate each of the computed fitness metrics into the aggregate fitness metric.

20. The non-transitory computer-readable storage medium of claim 19, the executable instructions, when executed by at least one processor, cause the at least one processor to:
compute the fitness metric for each location of the multiple locations in the first region based on:
$$F = {\int }_{p ∈ S , q ∈ U} … \int ( w ( d ( p , q ) ) dpdq ;$$
$$wherein :$$
$$d = \sqrt{{\sum }_{i = 1 to n} {( {p}_{i} - {q}_{i} )}^{2}} ;$$
and
wherein F represents the fitness metric, S and U represent the first and second regions, p and q represent points within the first and second regions, w(d) represents a weighting function with respect to points p and q, and d represents a Euclidean distance between the points p and q.
